(19) United States
(12) Patent Application Publication
(10) Pub. No.: US 2005/0015621 A1
(43) Pub. Date: Jan. 20, 2005

(54) Method and system for automatic adjustment of entitlements in a distributed data processing environment

(75) Inventors: Paul Anthony Ashley, Queensland (AU); Sridhar R. Muppidi, Austin, TX (US); Mark Vandenwauver, Round Rock, TX (US)

Correspondence Address: Joseph R. Burwell;Law Office of Joseph R. Burwell, P.O. Box 28022, Austin, TX, 78755-8022, US

(73) Assignee: INTERNATIONAL BUSINESS MACHINES CORPORATION, ARMONK, NY (US)

(21) Appl. No.: 10/621,935

(22) Filed: Jul. 17, 2003

(51) Int. Cl. H04L 9/00; G06F 11/30

(52) U.S. Cl. 713/201; 713/167; 709/226

(57) ABSTRACT

A method, system, and computer program product is presented for restricting access to a set of resources in a distributed data processing system. A server determines a set of authorized resources for which a user is authorized to access; the set of authorized resources is a subset of the set of resources that are operational within the distributed data processing system. An evaluation is made about the availability of the set of authorized resources based upon state information about the set of authorized resources. A list of a set of entitled resources for the user is then generated; the set of entitled resources is a subset of the set of authorized resources. An indication of the set of entitled resources may be sent to the user, after which the system would respond to requests for the user to access the set of entitled resources.

### BACKGROUND OF THE INVENTION

1. Field of the Invention

The present invention relates to an improved data processing system and, in particular, to a method and apparatus for multicomputer data transferring. Still more particularly, the present invention provides a method and apparatus for multicomputer distributed resource management.

2. Description of Related Art

A user registers with an organization to obtain access to online applications that are provided by the organization, such as e-commerce web sites and web applications that perform transactions over computer networks on behalf of the user. The user is associated with a set of entitlements, which are attributes that enable the user to access certain applications, accounts, or other controlled resources. For example, a user may be registered to use an online brokering application, and thereafter, the user may be considered to have an entitlement for the online brokering application. The user may also have other entitlements that are related to the online brokering application, e.g., access to real-time stock quotes.

When a user attempts to access an organization's online site, the user is challenged to complete an authentication operation. If the user is successfully authenticated, then based on the user's entitlements, the user is shown a list of applications or other controlled resources that the user may access. An entitlements engine that produces the entitlement data usually receives input data from a number of sources in order to create the list of entitlements for a user, such as a user registry, various authorization policies of the organization, and third-party source data.

Current entitlement systems, however, do not consider information about the real-time status of the computing environments in which they operate, which can produce inconsistent performance for the users of those systems. For example, an application may be unavailable due to failure, due to maintenance, or due to capacity limits that have been reached. Since an entitlement system is not aware of the status of the applications, the entitlement system may present the user with information about accessing these applications or other resources, e.g., as hyperlinks within a web page, even though the resources may not be available. If the user subsequently attempts to access a resource that has been offered but that is not available or that has already been fully loaded, then the user may experience availability problems, which gives the user the impression that the organization's computer systems, e.g., its web site, is not robust.

Therefore, it would be advantageous to have a method and a system that can automatically adjust user entitlements so that the user does not experience performance problems and inconsistent results.

### SUMMARY OF THE INVENTION

A method, system, and computer program product is presented for restricting access to a set of resources in a distributed data processing system. A server determines a set of authorized resources for which a user is authorized to access; the set of authorized resources is a subset of the set of resources that are operational within the distributed data processing system. An evaluation is made about the availability of the set of authorized resources based upon state information about the set of authorized resources. A list of a set of entitled resources for the user is then generated; the set of entitled resources is a subset of the set of authorized resources. An indication of the set of entitled resources may be sent to the user, after which the system would respond to requests for the user to access the set of entitled resources.

### BRIEF DESCRIPTION OF THE DRAWINGS

The novel features believed characteristic of the invention are set forth in the appended claims. The invention itself, further objectives, and advantages thereof, will be best understood by reference to the following detailed description when read in conjunction with the accompanying drawings, wherein:

FIG. 1A depicts a typical network of data processing systems, each of which may implement the present invention;

FIG. 1B depicts a typical computer architecture that may be used within a data processing system in which the present invention may be implemented;

FIG. 1C depicts a data flow diagram that illustrates a typical authentication process that may be used when a client attempts to access a protected resource at a server;

FIG. 1D depicts a block diagram that shows a typical distributed data processing system for an enterprise domain;

FIG. 2 depicts a block diagram that shows a distributed data processing system with an entitlement server that has been extended to include processing of status information that has been gathered within the distributed data processing system in accordance with the present invention;

FIG. 3 depicts a flowchart that shows a process for creating a set of entitlement rules that control an entitlement server;

FIG. 4A depicts a flowchart that shows a process for determining a set of resources to be shown to a user that are specifically authorized for the user and that have been specifically entitled for the user based on computational status information about the server-side environment;

FIG. 4B depicts a flowchart that shows a process for using a set of entitlement rules to generate a set of entitled resources for a user in accordance with an embodiment of the present invention; and

FIGS. 5A-5C depict a set of examples in which an entitlement server employs information about the utilization of resources in a server-side distributed data processing system to adjust the resources that are indicated as being available to users.

### DETAILED DESCRIPTION OF THE INVENTION

In general, the devices that may comprise or relate to the present invention include a wide variety of data processing technology. Therefore, as background, a typical organization of hardware and software components within a distributed data processing system is described prior to describing the present invention in more detail.

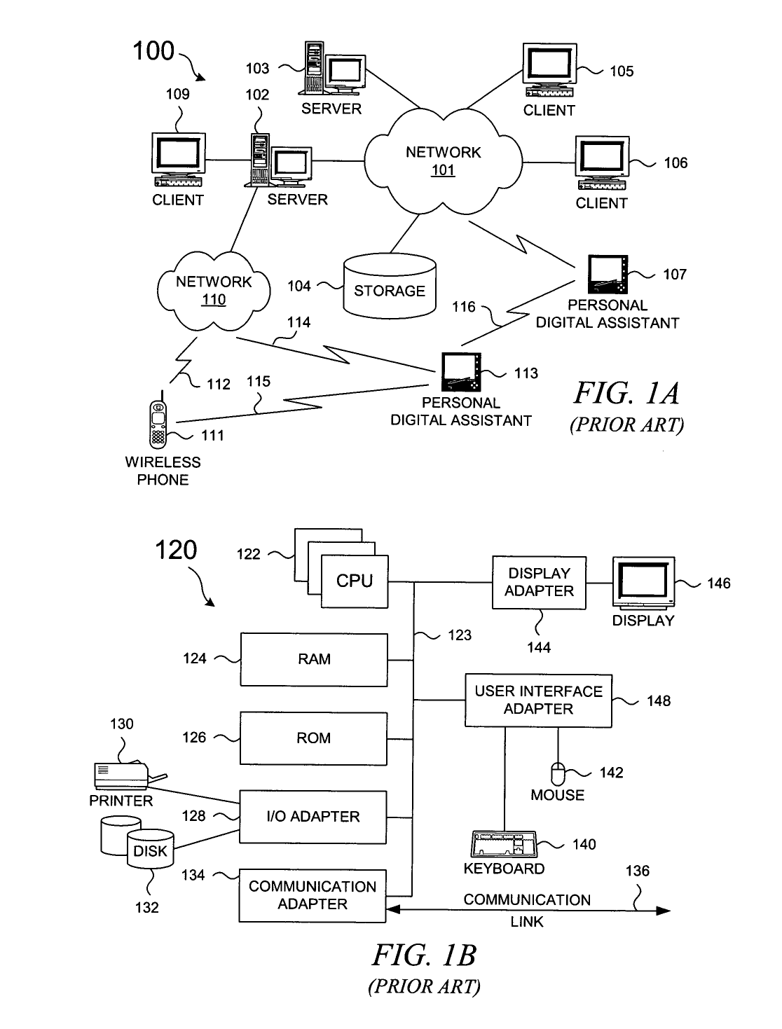

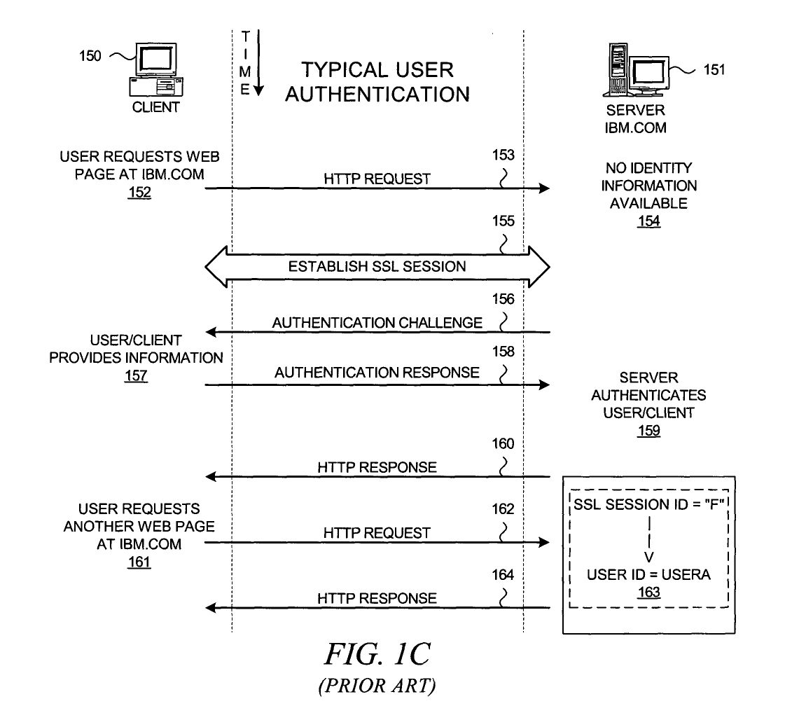

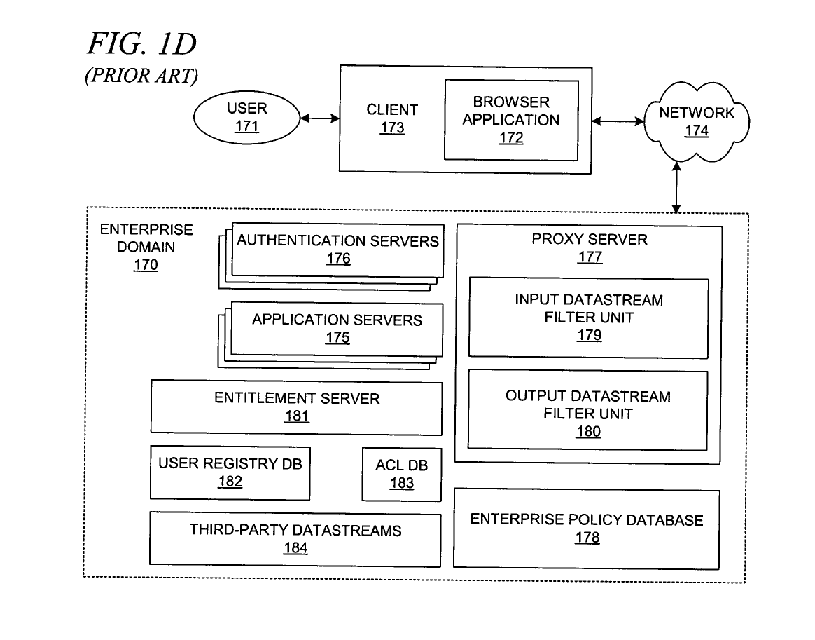

With reference now to the figures, FIG. 1A depicts a typical network of data processing systems, each of which may implement a portion of the present invention. Distributed data processing system 100 contains network 101, which is a medium that may be used to provide communications links between various devices and computers connected together within distributed data processing system 100. Network 101 may include permanent connections, such as wire or fiber optic cables, or temporary connections made through telephone or wireless communications. In the depicted example, server 102 and server 103 are connected to network 101 along with storage unit 104. In addition, clients 105-107 also are connected to network 101. Clients 105-107 and servers 102-103 may be represented by a variety of computing devices, such as mainframes, personal computers, personal digital assistants (PDAs), etc. Distributed data processing system 100 may include additional servers, clients, routers, other devices, and peer-to-peer architectures that are not shown.

In the depicted example, distributed data processing system 100 may include the Internet with network 101 representing a worldwide collection of networks and gateways that use various protocols to communicate with one another, such as Lightweight Directory Access Protocol (LDAP), Transport Control Protocol/Internet Protocol (TCP/IP), Hypertext Transport Protocol (HTTP), Wireless Application Protocol (WAP), etc. Of course, distributed data processing system 100 may also include a number of different types of networks, such as, for example, an intranet, a local area network (LAN), or a wide area network (WAN). For example, server 102 directly supports client 109 and network 110, which incorporates wireless communication links. Network-enabled phone 111 connects to network 110 through wireless link 112, and PDA 113 connects to network 110 through wireless link 114. Phone 111 and PDA 113 can also directly transfer data between themselves across wireless link 115 using an appropriate technology, such as Bluetooth™ wireless technology, to create so-called personal area networks (PAN) or personal ad-hoc networks. In a similar manner, PDA 113 can transfer data to PDA 107 via wireless communication link 116.

The present invention could be implemented on a variety of hardware platforms; FIG. 1A is intended as an example of a heterogeneous computing environment and not as an architectural limitation for the present invention.

With reference now to FIG. 1B, a diagram depicts a typical computer architecture of a data processing system, such as those shown in FIG. 1A, in which the present invention may be implemented. Data processing system 120 contains one or more central processing units (CPUs) 122 connected to internal system bus 123, which interconnects random access memory (RAM) 124, read-only memory 126, and input/output adapter 128, which supports various I/O devices, such as printer 130, disk units 132, or other devices not shown, such as an audio output system, etc. System bus 123 also connects communication adapter 134 that provides access to communication link 136. User interface adapter 148 connects various user devices, such as keyboard 140 and mouse 142, or other devices not shown, such as a touch screen, stylus, microphone, etc. Display adapter 144 connects system bus 123 to display device 146.

Those of ordinary skill in the art will appreciate that the hardware in FIG. 1B may vary depending on the system implementation. For example, the system may have one or more processors, such as an Intel® Pentium®-based processor and a digital signal processor (DSP), and one or more types of volatile and non-volatile memory. Other peripheral devices may be used in addition to or in place of the hardware depicted in FIG. 1B. The depicted examples are not meant to imply architectural limitations with respect to the present invention.

In addition to being able to be implemented on a variety of hardware platforms, the present invention may be implemented in a variety of software environments. A typical operating system may be used to control program execution within each data processing system. For example, one device may run a Unix® operating system, while another device contains a simple Java® runtime environment. A representative computer platform may include a browser, which is a well known software application for accessing hypertext documents in a variety of formats, such as graphic files, word processing files, Extensible Markup Language (XML), Hypertext Markup Language (HTML), Handheld Device Markup Language (HDML), Wireless Markup Language (WML), and various other formats and types of files.

The present invention may be implemented on a variety of hardware and software platforms, as described above with respect to FIG. 1A and FIG. 1B. More specifically, though, the present invention is directed to an improved data processing environment. Prior to describing the present invention in more detail, a typical distributed data processing environment is described.

The descriptions of the figures herein involve certain actions by either a client device or a user of the client device. One of ordinary skill in the art would understand that responses and/or requests to/from the client are sometimes initiated by a user and at other times are initiated automatically by a client, often on behalf of a user of the client. Hence, when a client or a user of a client is mentioned in the description of the figures, it should be understood that the terms “client” and “user” can be used interchangeably without significantly affecting the meaning of the described processes.

With reference now to FIG. 1C, a data flow diagram illustrates a typical authentication process that may be used when a client attempts to access a protected

The server determines that it does not have an active session for the client (step 154), so the server initiates and completes the establishment of an SSL (Secure Sockets Layer) session between the server and the client (step 155), which entails multiple transfers of information between the client and the server. After an SSL session is established, subsequent communication messages are transferred within the SSL session; any secret information remains secure because of the encrypted communication messages within the SSL session.

However, the server needs to determine the identity of the user before allowing the user to have access to protected resources, so the server requires the user to perform an authentication process by sending the client some type of authentication challenge (step 156). The authentication challenge may be in various formats, such as an HTML form. The user then provides the requested or required information (step 157), such as a username or other type of user identifier along with an associated password or other form of secret information.

The authentication response information is sent to the server (step 158), at which point the server authenticates the user or client (step 159), e.g., by retrieving previously submitted registration information and matching the presented authentication information with the user's stored information. Assuming the authentication is successful, an active session is established for the authenticated user or client.

The server then retrieves the originally requested web page and sends an HTTP response message to the client (step 160), thereby fulfilling the user's original request for the protected resource. At that point, the user may request another page within “ibm.com” (step 161) by clicking a hypertext link within a browser window, and the browser sends another HTTP request message to the server (step 162). At that point, the server recognizes that the user has an active session (step 163), and the server sends the requested web page back to the client in another HTTP response message (step 164).

With reference now to FIG. 1D, a block diagram depicts a typical distributed data processing system for an enterprise domain. As in a typical corporate computing environment or an Internet-based computing environment, enterprise domain 170 hosts controlled resources that user 171 can access, e.g., by using browser application 172 on client device 173 through network 174. Application servers 175 support accessible resources through web-based applications or other types of applications, including legacy applications. Authentication servers 176 support various authentication mechanisms, such as username/password, X.509 certificates, or secure tokens. Enterprise domain 170 supports multiple servers. Proxy server 177 performs a wide range of functions for enterprise domain 170. Proxy server 177 can be administratively configured through configuration files and enterprise policy database 178 to control the functionality of proxy server 177, e.g., caching web pages in order to mirror the content from an application server or filtering the incoming and outgoing datastreams through input datastream filter unit 179 and output datastream filter unit 180. Input datastream filter unit 179 may perform multiple checks on incoming requests while output datastream filter unit 180 may perform multiple checks on outgoing responses; each check may be performed in accordance with goals and conditions that are specified within various enterprise policies.

Enterprise domain 170 comprises entitlements server 181, which accepts information within user registry database 182, access control list (ACL) database 183, and third-party datastreams 184 from other domains. Entitlements server 181 determines whether users are authorized to access certain services that are provided by application servers 175 within domain 170 by checking policies and/or access control lists against user requests for those services. A set of user-specific entitlements is used by proxy server 177, entitlement server 181, or a combined or coordinated effort between proxy server 177 and entitlement 181 to determine or control access to application servers 175 and other controlled resources in response to user requests.

The above-noted entities within enterprise domain 170 represent typical entities within many computing environments. As was shown with respect to FIG. 1C, web-based applications can utilize various means to prompt users to enter authentication information, often as a username/password combination within an HTML form. In the example that is shown in FIG. 1D, user 171 may be required to be authenticated before client 173 may have access to resources, after which a session is established for client 173 in a manner similar to that described above in FIG. 1C. In FIG. 1D, after receiving an incoming request from client 173, input datastream filter unit 179 may determine whether client 173 has already established a session; if not, an authentication service on authentication servers 176 can be invoked in order to authenticate user 171. If client 173 has already established a session, then additional checks may be performed on an incoming request prior to granting access to a controlled resource; the additional checks may be specified in an enterprise authentication policy.

Turning now to focus on the present invention, it was noted above that some distributed data processing systems have problems in providing consistent performance and results to users of those distributed data processing systems. The present invention is directed to an improved entitlement server that is extended with functionality to automatically adjust its processing with respect to state information or status information about the distributed data processing environment in which it is operating. The present invention is described in more detail below with respect to the remaining figures.

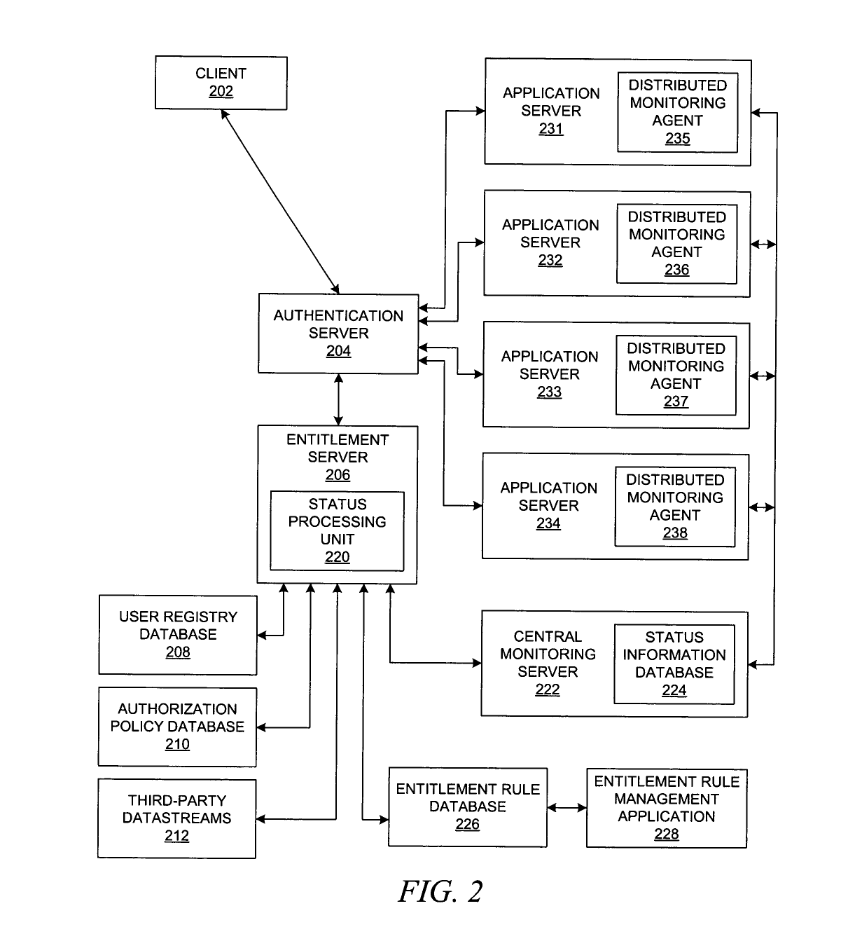

With reference now to FIG. 2, a block diagram depicts a distributed data processing system with an entitlement server that has been extended to include processing of status information that has been gathered within the distributed data processing system in accordance with the present invention. The entities that are shown in FIG. 2 differ from the entities that are shown in FIG. 1D, but FIG. 2 represents a distributed data processing system with similar functionality to that shown in FIG. 1D; for example, FIG. 2 shows an authentication server that also contains functionality for acting as a proxy server. Other entities may be contained but not shown within the distributed data processing system of FIG. 2.

In a manner similar to that described above with respect to FIG. 1D, client 202 supports a web browser application or a similar type of user application for accessing resources and services from various applications, such as e-commerce servers. A distributed data processing system that is operated by an organization, such as an e-commerce enterprise, comprises authentication server 204 and a set of application servers for responding to client-originated resource requests. Entitlement server 206 accepts information from user registry database 208, authorization policy database 210, and third-party datastreams 212 from other domains. Entitlements server 206 determines whether users are authorized to access certain services that are provided by associated application servers by checking policies and/or access control lists against user requests for those services. A set of user-specific entitlements that is provided by entitlement server 206 to authentication server 204 is used by authentication server 204 to determine or control access to application servers and other controlled resources in response to user requests.

In contrast to FIG. 1D, FIG. 2 depicts a distributed data processing system with an entitlement server that has been extended to include processing of status information that has been gathered within the distributed data processing system. Entitlement server 206 has been extended to include status processing unit 220, which obtains state information about its computational environment from central monitoring server 222 and its status information database 224. Entitlement server 206 is responsible for determining which applications or other resources are indicated as available from the distributed data processing system to a specific user. The operation of entitlement server 206 is controlled through the use of entitlement rules that are stored within entitlement rule database 226 and that are managed through entitlement rule management application 228. Entitlement server 206 obtains status information about those resources and accounts for the status information in the resources that it reports are available to a specific user.

Entitlement server 206 may obtain information from the central monitoring server through a variety of operations: in response to a request that it sends to the central monitoring server; as a periodic or scheduled transfer of information that is initiated by the central monitoring server; or in some other manner. In the example that is shown in FIG. 2, the central monitoring server is depicted as an independent entity, but in alternative embodiments, the functionality that is associated with a central datastore for the status information could be incorporated into a proxy server, authentication server, authorization server, entitlement server, or some other entity that is associated with the determination of the set of user-specific entitlements at a given point in time.

Information about the state of the server-side data processing system may be acquired through a variety of techniques. As a first example, a proxy server could ping the application servers to determine whether an application server actively and/or quickly responds to the ping, and if not, then the proxy server could mark the application server as offline until it responds to some form of request from the proxy server. In the example that is shown in FIG. 2, each of application servers 231-234 include a distributed monitoring agent, such as distributed monitoring agents 235-238. A distributed monitoring agent monitors computational resources and/or metrics on its respective application server. A variety of general computer resources may be monitored, such as CPU utilization or memory load, and/or a variety of application-specific resources may be monitored, such as the number of client requests that are being simultaneously serviced. The resource that is being monitored may actively assist in reporting its status, or an information gathering agent may passively detect the status or state of a resource. Each distributed monitoring agent reports its measured values to central monitoring server 220, which stores the gathered values into status information database 222. The data collection operation may be performed in a variety of manners. For example, the agents may send the collected data: periodically; in accordance with a configurable schedule; in response to a polling request from the central monitoring server; or in some other manner.

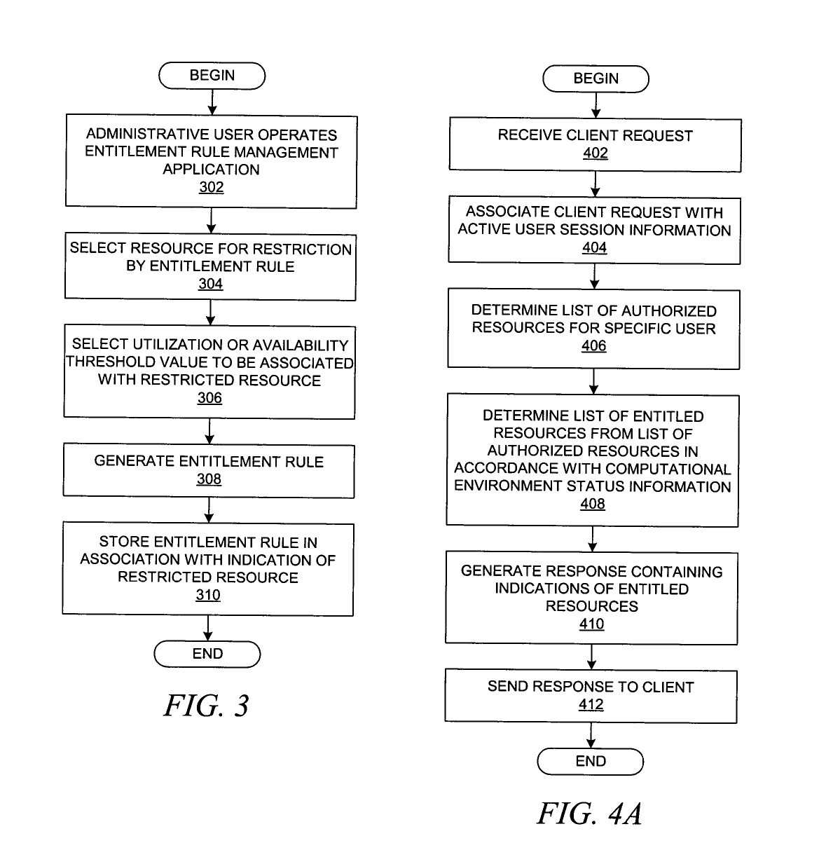

With reference now to FIG. 3, a flowchart depicts a process for creating a set of entitlement rules that control an entitlement server in accordance with an embodiment of the present invention. The process begins with an administrative user or some other type of user with special server-side privileges operating an entitlement rule management application (step 302), such as is shown in FIG. 2. The administrator selects a resource to be restricted through the management application (step 304). The resource may be selected from a list of computational resources within the server-side computational environment as presented to the administrator by the management application. The list of computational resources that are restrictable through the management application may also be configured through the management application. The administrator then selects or enters a utilization or availability threshold value to be associated with the selected resource (step 306). An entitlement rule is then generated (step 308), and the newly generated entitlement rule is stored in association with an indication of the selected resource (step 310), thereby concluding the process.

The format of the entitlement rules may vary with different embodiments of the present invention. As an example, the entitlement rules may be regular expressions containing variables that represent the utilization of computational resources within the server-side data processing environment. Values for the variables are gathered or accumulated by a distributed monitoring system or through some form of status information acquiring process. The computational resources may be hardware-related or software-related. The particular resources that may be restricted may vary with the type of computational environment, the applications that are potentially available to users, various business goals of an organization that is operating the enterprise domain, or other considerations. In the simplest case, a single utilization level may be associated with a resource; in more complex cases, utilization or availability values of multiple resources may incorporated into a single entitlement rule. Moreover, the entitlement rules are not limited to variables that represent computational resources but may also include variables that are related to user attributes, as described in more detail further below.

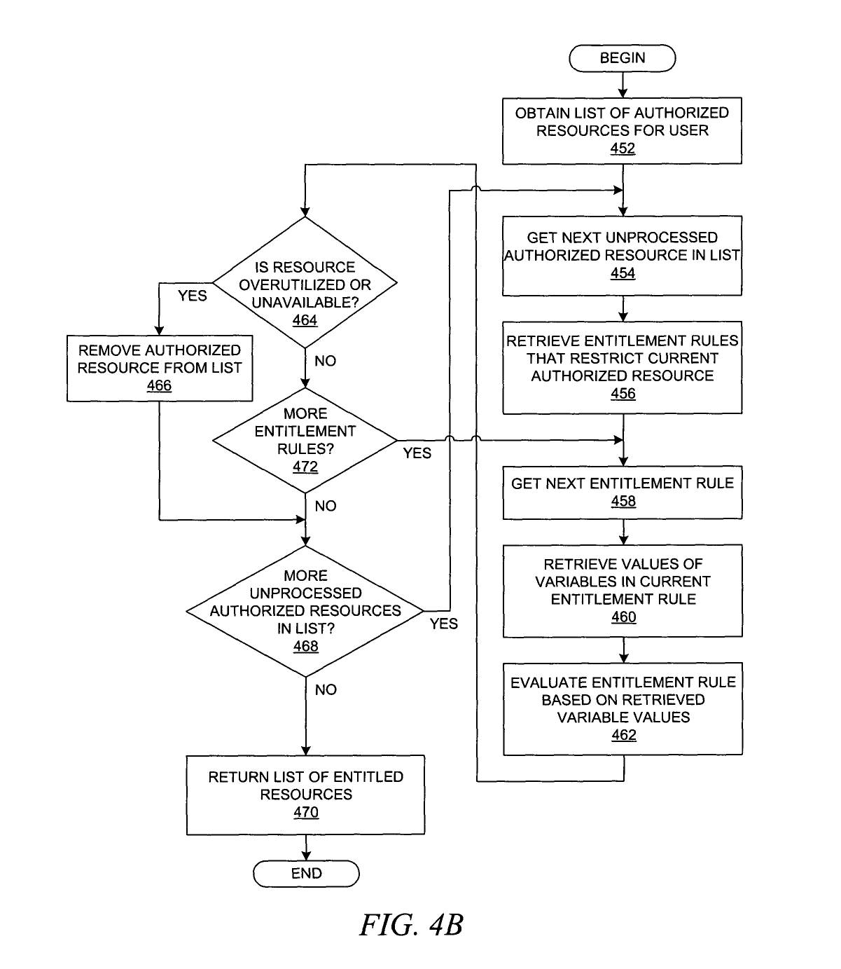

With reference now to FIG. 4A, a flowchart depicts a process for determining a set of resources to be shown to a user that are specifically authorized for the user and that have been specifically entitled for the user based on computational status information about the server-side environment in accordance with an embodiment of the present invention. The process begins with the receipt of a request from a client device that is operated by a user (step 402). Although the process of determining entitled resources may be performed in conjunction with an authentication operation, it may be assumed that the user has already been authenticated, so the client request is associated with information about an active user session (step 404). For example, an authorization policy that was retrieved and cached for the user during an authentication operation can be retrieved based upon a session identifier that is associated with the user. A list of authorized resources for this specific user is then determined based on the identity of the user, the appropriate authorization policies, or other considerations (step 406).

In contrast to prior art systems in which a set of authorized resources are presented to the user as being available for use by the user, the present invention narrows the list of available resources to determine a list of entitled resources in accordance with computational environment status information (step 408). A response to the client is then generated with indications of the entitled resources (step 410); in other words, the response contains only those resources that are user-specific in view of the user authorization policy and that are entitlement-specific in view of the availability of the computational resources. The response is then sent to the user's client device (step 412), and the process is concluded.

With reference now to FIG. 4B, a flowchart depicts a process for using a set of entitlement rules to generate a set of entitled resources for a user in accordance with an embodiment of the present invention. FIG. 4B provides additional detail for steps 406 and 408 in FIG. 4A for determining a list of entitled resources as a subset of authorized resources for a specific user.

The process begins by obtaining a list of authorized resources for a user that is attempting to access resources (step 452). As described in more detail below, the process loops through the list of authorized resources by processing each entry in the list to determine whether that particular entry should remain in a list of entitled resources. In this manner, the list of authorized resources is processed until the remaining list of authorized resources may be regarded as a list of entitled resources. Hence, the process gets a next authorized resource in the list of authorized resources (step 454), e.g., an identifier for the authorized resource, thereafter considered to be the current authorized resource, i.e. the authorized resource that is currently being processed.

Any entitlement rules that restrict or refer to the current authorized resource are then retrieved from an appropriate datastore (step 456). Hereinafter, the process loops through the list of entitlement rules by processing each entry in the list of entitlement rules to determine whether a particular entitlement rule renders a particular authorized resource or a set of authorized resources as being unavailable to the user. Hence, the process gets a next entitlement rule in the list of entitlement rules (step 458), thereafter considered to be the current entitlement rule, i.e. the entitlement rule that is currently being processed.

The values of variables within the current entitlement rule are retrieved (step 460), and the entitlement rule is evaluated based on the retrieved variable values (step 462). The values may be retrieved from user attributes that are stored in a user registry, from a server status information database, or some other type of datastore.

A determination is then made as to whether or not the entitlement rule evaluates to an assertion that the current authorized resource should be regarded as over-utilized or unavailable (step 464). If so, then the authorized resource is removed from the list of authorized resources (step 466); in this manner, the list of authorized resources is possibly reduced entry-by-entry. A determination is then made as to whether or not there are any authorized resources in the list of authorized resources that remain unprocessed (step 468). If not, then the processed list of zero or more remaining authorized resources now represents the list of zero or more entitled resources that is returned to the calling function (step 470), and the process is concluded.

If the current entitlement rule does not evaluate to an assertion that the current authorized resource should be regarded as over-utilized or unavailable at step 464, then the current authorized resource is not removed from the list of authorized resources at step 466. Instead, a determination is made as to whether or not there are more entitlement rules that are associated with the current authorized resource (step 472). If so, then the process branches back to step 458 to obtain and evaluate another entitlement rule. If there are no additional entitlement rules to be evaluated, then the process branches to step 468 to check if there are any additional authorized resources that have not yet been processed. If there are authorized resources in the list of authorized resources that remain unprocessed at step 468, then the process branches back to step 454 to obtain and process the next authorized resource in the list of authorized resources. As mentioned above, after the entire list of authorized resources has been processed, the remaining list of authorized resources also represents the list of resources to which the user is entitled to access.

The advantages of the present invention should be apparent in view of the detailed description that is provided above. In the prior art, an entitlement engine determines a list of entitled resources for a user based on the resources that the user was authorized to access. In contrast, the present invention provides an entitlement engine which incorporates consideration of the state of its computational environment while determining the list of available resources that should be presented to a user of the servers within the computational environment. Using the present invention, the system does not present to the user information about a set of resources when those resources have already passed a threshold condition. The conditions might entail considerations of the fact that the user would likely experience poor performance during these conditions. Other considerations could include an entitlement decision to reserve those resources based on user attributes, as explained in more detail with respect to the example provided below.

One manner of viewing the advantages of the present invention is that the present invention proactively prevents users from obtaining an ability to request certain resources because of the state of the server-side system, even though the user would be authorized to request those resources under different server-side conditions; the user's entitled resources are always a subset of the user's normally authorized resources, although the set of entitled resources may be equal to or as extensive as the set of authorized resources. By proactively preventing users from pushing the server-side system into a more over-utilized condition, the present invention alleviates some of the need for certain server-side solutions that attempt to adjust server-side processing to accommodate over-utilized conditions.

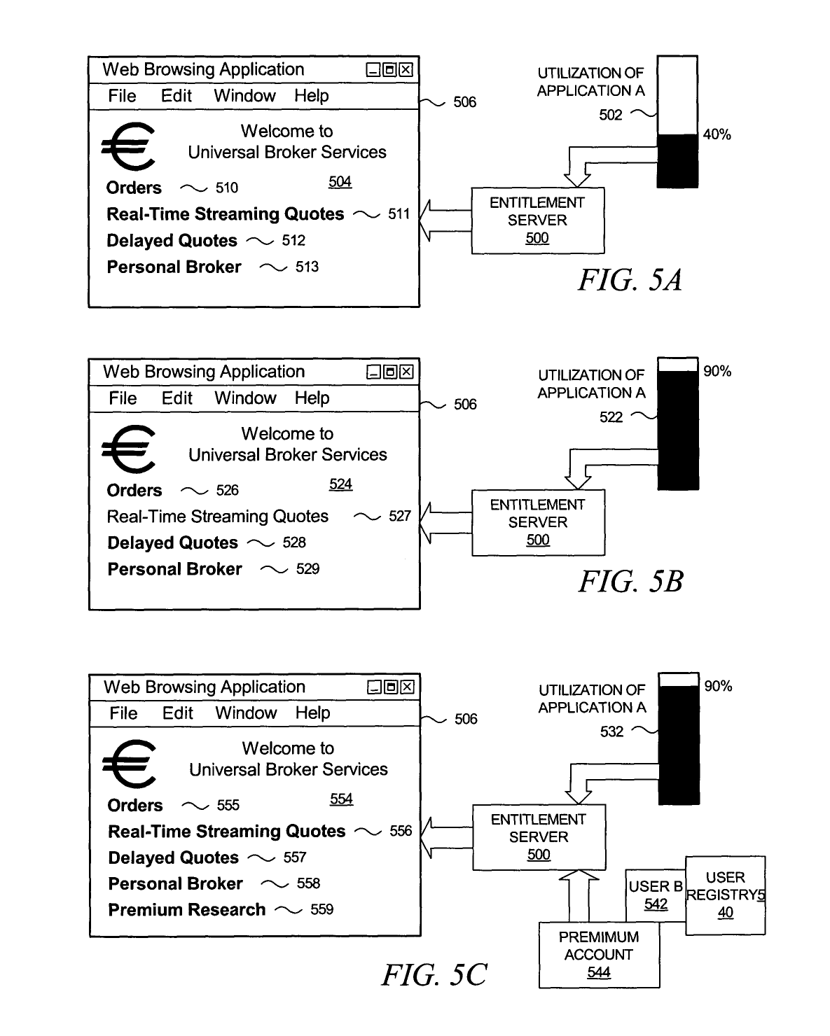

With respect to FIGS. 5A-5C, a set of diagrams depict a set of examples in which an entitlement server employs information about the utilization of resources in a server-side distributed data processing system to adjust the resources that are indicated as being available to users. FIGS. 5A-5C represent general considerations or dataflows and is not intended to show detail for various computational entities that may be involved in the operation of an e-commerce web site. In this set of examples, an online broker service operates a web site for its registered customers. Assuming that a user successfully completes an authentication challenge in response to a user request to access the web site, then an entitlement server needs to determine which services should be indicated as being available to the user.

Referring now to FIG. 5A, entitlement server 500 receives status information 502 for the level of utilization of an application, which in this example is an application that generates a real-time datastream of stock and bond quotes. In this set of examples, a system administrator may have previously determined that the real-time quote streaming application provides poor response times or inconsistent performance when its utilization rises too high. To prevent an over-utilized condition, the system administrator has previously created an entitlement rule that indicates that the real-time quote streaming application should only be indicated as being available to users if the application is below a 70% utilization level. Since the entitlement server receives a 40% utilization value for the real-time quote streaming application, the entitlement server determines that the real-time quote streaming application should be indicated as available. Entitlement server might provide a list of entitled resources to another server that dynamically generates web page 504 that is sent to a client. A web browser application at the client displays window 506 that shows a list of entitled resources 510-513 that are available to the user through the online broker web site; the list of entitled resources might be represented by hyperlinks or some other type of user-selectable controls that are embedded within a web page. In this example, hyperlink 511 represents the availability of the real-time quote streaming application; the user can select hyperlink 511 to access the functionality of the real-time quote streaming application.

Referring now to FIG. 5B, entitlement server 500 receives status information 522 for the level of utilization of an application, which in this example is also an application that generates a real-time datastream of stock and bond quotes. Again, a system administrator has previously created an entitlement rule that indicates that the real-time quote streaming application should only be indicated as being available to users if the application is below a 70% utilization level. Since the entitlement server receives a 90% utilization value for the real-time quote streaming application, the entitlement server determines that the real-time quote streaming application should not be indicated as available.

In this example, web page 524 that is sent to a client does not contain a hyperlink for the real-time quote streaming application in the list of entitled resources 526-529. Instead, the real-time quote streaming application is merely represented by text string 527 with different font attributes that indicate that text string 527 is plain text and does not represent a hyperlink, thereby indicating to the user that the web page does not contain a user-selectable control for the real-time quote streaming application; other information may be presented that explains why the real-time quote streaming application is unavailable. Hence, the user is not presented with an indication that the real-time quote streaming application is available, and the user cannot initiate a request to access the real-time quote streaming application, even though the user is authorized to access the real-time quote streaming application. Moreover, in a system that incorporates the present invention, it would generally be the case that the user may be prevented from accessing any resources that are not in the list of entitled resources. In this manner, the entitlement server has proactively alleviated further utilization of the real-time quote streaming application by authorized users in accordance with the entitlement rules that were configured by a system administrator.

Referring now to FIG. 5C, entitlement server 500 receives status information 532 for the level of utilization of a real-time datastream of stock and bond quotes. In the example that is shown in FIG. 5C, a more complex entitlement rule is active than the entitlement rule that was used in the examples in FIGS. 5A and 5B. A system administrator has previously created an entitlement rule that indicates that the real-time quote streaming application should only be indicated as being available to standard users if the application is below a 70% utilization level; however, if the user has a premium account, the real-time quote streaming application is available until the utilization value reaches 95%.

In this case, the entitlement server accesses user registry 540 to obtain user-specific attributes for the user as stored in user account 542, and the entitlement server discovers user attribute 544 that indicates that the user has previously subscribed to a premium account. Since the entitlement server determines that the user has a premium account, and since the entitlement server receives a 90% utilization value for the real-time quote streaming application, the entitlement server then determines that the real-time quote streaming application should be indicated as available for this particular user. Entitlement server provides a list of entitled resources to another server that dynamically generates web page 554 that is sent to a client. A web browser application at the client displays window 506 that shows a list of entitled resources 555-539 that are available to the premium user through the online broker web site; the list of entitled resources might be represented by hyperlinks or some other type of user-selectable controls that are embedded within a web page. In this example, hyperlink 539 represents a premium resource that is accessible to users with a premium account. More importantly, hyperlink 556 represents the availability of the real-time quote streaming application; the user can select hyperlink 556 to access the functionality of the real-time quote streaming application.

In the example that is shown in FIG. 5C, the server-side system has determined that the user would normally be authorized to access a particular resource, e.g., the real-time quote streaming application. After determining the utilization factor for the resource, an entitlement rule indicates that some users that are authorized to access the resource are not entitled to access the resource, while other users that have a different user attribute are entitled to access the resource. Some users are presented with an indication that a resource is available while other users are not provided with an indication that the resource is available; some users can initiate additional requests to access the resource, and other users cannot initiate a request to access the resource, even though all of the users are authorized to access the resource. Again, the entitlement server has proactively alleviated further utilization of the real-time quote streaming application by some authorized users while reserving a utilization buffer of 5% to ensure that the users with the premium accounts experience a sufficient level of service from the resource.

It is important to note that while the present invention has been described in the context of a fully functioning data processing system, those of ordinary skill in the art will appreciate that the processes of the present invention are capable of being distributed in the form of instructions in a computer readable medium and a variety of other forms, regardless of the particular type of signal bearing media actually used to carry out the distribution. Examples of computer readable media include media such as EPROM, ROM, tape, paper, floppy disc, hard disk drive, RAM, and CD-ROMs and transmission-type media, such as digital and analog communications links.

A method is generally conceived to be a self-consistent sequence of steps leading to a desired result. These steps require physical manipulations of physical quantities. Usually, though not necessarily, these quantities take the form of electrical or magnetic signals capable of being stored, transferred, combined, compared, and otherwise manipulated. It is convenient at times, principally for reasons of common usage, to refer to these signals as bits, values, parameters, items, elements, objects, symbols, characters, terms, numbers, or the like. It should be noted, however, that all of these terms and similar terms are to be associated with the appropriate physical quantities and are merely convenient labels applied to these quantities.

The description of the present invention has been presented for purposes of illustration but is not intended to be exhaustive or limited to the disclosed embodiments. Many modifications and variations will be apparent to those of ordinary skill in the art. The embodiments were chosen to explain the principles of the invention and its practical applications and to enable others of ordinary skill in the art to understand the invention in order to implement various embodiments with various modifications as might be suited to other contemplated uses. resource at a server. As illustrated, the user at a client workstation 150 seeks access over a computer network to a protected resource on a server 151 through the user's web browser executing on the client workstation. A protected or controlled resource is a resource (an application, an object, a document, a page, a file, executable code, or other computational resource, communication-type resource, etc.) for which access is controlled or restricted. A protected resource is identified by a Uniform Resource Locator (URL), or more generally, a Uniform Resource Identifier (URI), that can only be accessed by an authenticated and authorized user. The computer network may be the Internet, an intranet, or other network, as shown in FIG. 1A or FIG. 1B, and the server may be a web application server (WAS), a server application, a servlet process, or the like.

The process is initiated when the user requests a server-side protected resource, such as a web page within the domain “ibm.com” (step 152). The terms “server-side” and “client-side” refer to actions or entities at a server or a client, respectively, within a networked environment. The web browser (or associated application or applet) generates an HTTP request (step 153) that is sent to the web server that is hosting the domain “ibm.com”. The terms “request” and “response” should be understood to comprise data formatting that is appropriate for the transfer of information that is involved in a particular operation, such as messages, communication protocol information, or other associated information.

1. A method for restricting access to a set of resources in a distributed data processing system, the method comprising:
determining a set of authorized resources for which a user is authorized to access, wherein the set of authorized resources is a subset of the set of resources;
obtaining state information about the set of authorized resources;
evaluating availability of the set of authorized resources based upon the state information about the set of authorized resources; and
in response to evaluating availability of the set of authorized resources, generating a list of a set of entitled resources for the user, wherein the set of entitled resources is a subset of the set of authorized resources.

2. The method of claim 1 further comprising:
sending an indication of the set of entitled resources to the user.

3. The method of claim 1 further comprising:
responding to requests for the user to access the set of entitled resources.

4. The method of claim 1 further comprising:
preventing the user from accessing resources that are in the set of authorized resources but that are not in the set of entitled resources.

5. The method of claim 1 further comprising:
considering user attributes of the user while evaluating availability of the set of authorized resources.

6. The method of claim 1 further comprising:
performing the evaluation of availability of the set of authorized resources in accordance with a configurable rule associated with one or more resources in the set of authorized resources.

7. The method of claim 1 further comprising:
gathering state information for the set of resources using a distributed monitoring application.

8. An apparatus for restricting access to a set of resources in a distributed data processing system, the apparatus comprising:
means for determining a set of authorized resources for which a user is authorized to access, wherein the set of authorized resources is a subset of the set of resources;
means for obtaining state information about the set of authorized resources;
means for evaluating availability of the set of authorized resources based upon the state information about the set of authorized resources; and
means for generating a list of a set of entitled resources for the user in response to evaluating availability of the set of authorized resources, wherein the set of entitled resources is a subset of the set of authorized resources.

9. The apparatus of claim 8 further comprising:
means for sending an indication of the set of entitled resources to the user.

10. The apparatus of claim 8 further comprising:
means for responding to requests for the user to access the set of entitled resources.

11. The apparatus of claim 8 further comprising:
means for preventing the user from accessing resources that are in the set of authorized resources but that are not in the set of entitled resources.

12. The apparatus of claim 8 further comprising:
means for considering user attributes of the user while evaluating availability of the set of authorized resources.

13. The apparatus of claim 8 further comprising:
means for performing the evaluation of availability of the set of authorized resources in accordance with a configurable rule associated with one or more resources in the set of authorized resources.

14. The apparatus of claim 8 further comprising:
means for gathering state information for the set of resources using a distributed monitoring application.

15. A computer program product in a computer readable medium for use in a distributed data processing system for restricting access to a set of resources, the computer program product comprising:
means for determining a set of authorized resources for which a user is authorized to access, wherein the set of authorized resources is a subset of the set of resources;
means for obtaining state information about the set of authorized resources;
means for evaluating availability of the set of authorized resources based upon the state information about the set of authorized resources; and
means for generating a list of a set of entitled resources for the user in response to evaluating availability of the set of authorized resources, wherein the set of entitled resources is a subset of the set of authorized resources.

16. The computer program product of claim 15 further comprising:
means for sending an indication of the set of entitled resources to the user.

17. The computer program product of claim 15 further comprising:
means for responding to requests for the user to access the set of entitled resources.

18. The computer program product of claim 15 further comprising:
means for preventing the user from accessing resources that are in the set of authorized resources but that are not in the set of entitled resources.

19. The computer program product of claim 15 further comprising:
means for considering user attributes of the user while evaluating availability of the set of authorized resources.

20. The computer program product of claim 15 further comprising:
means for performing the evaluation of availability of the set of authorized resources in accordance with a configurable rule associated with one or more resources in the set of authorized resources.

21. The computer program product of claim 15 further comprising:
means for gathering state information for the set of resources using a distributed monitoring application.
